(19) United States
(12) Patent Application Publication
(10) Pub. No.: US 2023/0413862 A1
(43) Pub. Date: Dec. 28, 2023

(54) BEER-TASTE BEVERAGE AND METHOD FOR PRODUCING BEER-TASTE BEVERAGE

(71) Applicant: SUNTORY HOLDINGS LIMITED, Osaka-shi, Osaka (JP)

(72) Inventors: Anna Ishizuka, Tokyo (JP); Yuichi Kato, Tokyo (JP)

(73) Assignee: SUNTORY HOLDINGS LIMITED, Osaka-shi, Osaka (JP)

(21) Appl. No.: 18/037,651

(22) PCT Filed: Nov. 29, 2021
(86) PCT No.: PCT/JP2021/043536

§ 371 Date: May 18, 2023

(30) Foreign Application Priority Data
Dec. 1, 2020 (JP) 2020-199320

(51) Int. Cl. A23L 2/38; A23L 2/54; C12C 11/00; C12C 12/04

(52) U.S. Cl. CPC A23L 2/382; A23L 2/54; C12C 11/003; C12C 12/04

(57) ABSTRACT

A beer-taste beverage, in which a bitterness value is 18 BUs or less, the total nitrogen amount is 5 to 140 mg/100 mL, the total polyphenol amount is 3 to 200 ppm by mass, and the content of 2,3-diethyl-5-methylpyrazine is 0.02 ppb by mass or more.

### TECHNICAL FIELD

The present invention relates to a beer-taste beverage and a method for producing the beer-taste beverage.

### BACKGROUND ART

For beer-taste beverages such as a common beer and a low-malt beer, malts and hops are used as main raw materials. By using malts as raw materials, a beverage having a malt-derived taste (i.e. umami) and a rich taste can be produced. On the other hand, by using hops as raw materials, a beverage having a rich flavor that is based on hop-specific bitterness, astringency and other flavors can be produced.

In recent years, it is said that consumers who do not like hop-derived bitterness or astringency have increased, and thus that the consumption of beer-taste beverages has made a little progress. The development of beer-taste beverages, in which hops are not used as raw materials, has been promoted (for example, Patent Publication (Kokai)No. 2017-6077 A (Patent Literature 1)).

However, there are some beer-taste beverages of not using hops, in which a tight feeing is insufficient and thus a flavor becomes weak.

### CITATION LIST

### Patent Literature

Patent Literature 1: Patent Publication (Kokai)No. 2017-6077 A

### SUMMARY OF INVENTION

### Technical Problem

It has been desired to develop a beer-taste beverage in which the amount of hops used is suppressed, wherein the beer-taste beverage has a flavor suitable for beer-taste beverages and also, a tight feeling suitable for beer-taste beverages.

### Solution to Problem

The present invention provides a beer-taste beverage in which the amount of hops used is suppressed, wherein the total nitrogen amount is 5 to 140 mg/100 mL, the total polyphenol amount is 3 to 200 ppm by mass, and the content of 2,3-diethyl-5-methylpyrazine is 0.02 ppb by mass or more.

The present invention includes the inventions of the following embodiments.

[1]

A beer-taste beverage, in which a bitterness value is 18 BUs or less, the total nitrogen amount is 5 to 140 mg/100 mL, the total polyphenol amount is 3 to 200 ppm by mass, and the content of 2,3-diethyl-5-methylpyrazine is 0.02 ppb by mass or more.

[2]

The beer-taste beverage according to the above [1], wherein the bitterness value is 5 BUs or less.

[3]

The beer-taste beverage according to the above [1] or [2], which does not substantially contain components derived from hops.

[4]

The beer-taste beverage according to any one of the above [1] to [3], wherein the content of 2,3-diethyl-5-methylpyrazine is 100 ppb by mass or less.

[5]

The beer-taste beverage according to any one of the above [1] to [4], wherein the original wort extract (0-Ex) concentration is 5% to 18% by mass.

[6]

The beer-taste beverage according to any one of the above [1] to [5], wherein the total nitrogen amount (mg/100 mL)/the total polyphenol amount (ppm by mass) is 0.2 to 3.0.

[7]

The beer-taste beverage according to any one of the above [1] to [6], wherein at least a portion of nitrogen or polyphenol is derived from malts.

[8]

The beer-taste beverage according to any one of the above [1] to [7], wherein at least a portion of nitrogen or polyphenol is derived from coms.

[9]

The beer-taste beverage according to any one of the above [1] to [8], wherein the percentage of malts used is 90% by mass or less.

[10]

The beer-taste beverage according to any one of the above [1] to [8], wherein the percentage of malts used is 0% by mass.

[11]

The beer-taste beverage according to any one of the above [1] to [10], wherein the beer-taste beverage is a fermented beer-taste beverage.

[12]

The beer-taste beverage according to any one of the above [1] to [10], wherein the beer-taste beverage is anon-fermented beer-taste beverage.

[13]

A method for producing the beer-taste beverage according to the above [11], which comprises:

a step of adding a yeast to water and raw materials that can be assimilated by the yeast, and performing alcoholic fermentation.

[14]

The method for producing the beer-taste beverage according to the above [13], wherein the raw materials that can be assimilated by the yeast comprise malts and coms, and the percentage of malts used is 90% by mass or less.

### Advantageous Effects of Invention

According to one preferred embodiment of the present invention, provided is a beer-taste beverage in which the amount of hops used is suppressed, wherein the beer-taste beverage has a flavor suitable for beer-taste beverages and also, a tight feeling suitable for beer-taste beverages.

### DESCRIPTION OF EMBODIMENTS

### 1. Beer-Taste Beverage

The beer-taste beverage of the present invention is a beer-taste beverage, in which a bitterness value is 18 BUs or less, the total nitrogen amount is 5 to 140 mg/100 mL, the total polyphenol amount is 3 to 200 ppm by mass, and the content of 2,3-diethyl-5-methylpyrazine is 0.02 ppb by mass or more.

In the present description, the “beer-taste beverage” means an alcoholic or non-alcoholic carbonated beverage having a beer-like flavor. That is to say, the beer-taste beverage described in the present description includes all carbonated beverages having a beer flavor, unless otherwise specified. Therefore, the present beer-taste beverage is not limited to beverages produced by adding a yeast to a wort and then performing a fermentation, but it also includes all carbonated beverages having a beer flavor, to which beer flavors including esters, higher alcohols (for example, isoamyl acetate, ethyl acetate, n-propanol, isobutanol, acetaldehyde, ethyl caproate, linalool, 4-vinylguaiacol, isoamyl propionate, etc.), acids (for example, 2-methyl-2-pentenoic acid and 4-methyl-3-pentenoic acid), and the like are added.

The beer-taste beverage of the present invention is not limited to a fermented beverage that is produced by adding a yeast to a pre-fermentation solution comprising a wort and components necessary for fermentation and then performing fermentation, but the beer-taste beverage of the present invention also includes fermented carbonated beverages and non-fermented carbonated beverage, to which beer flavors (i.e. flavors that evoke a beer-like flavor) including esters, higher alcohols and lactones, such as, for example, isoamyl acetate, ethyl acetate, n-propanol, isobutanol, acetaldehyde, ethyl caproate, ethyl caprylate, isoamyl propionate, linalool, geraniol, citral, 4-vinylguaiacol (4-VG), 4-methyl-3-pentenoic acid, 2-methyl-2-pentenoic acid, 1,4-cineole, 1,8-cineole, 2,3-diethyl-5-methylpyrazine, γ-decanolactone, γ-undecalactone, ethyl hexanoate, ethyl 2-methylbutyrate, ethyl n-butyrate, myrcene, methional, furfural, and furaneol, are added. The non-alcoholic beer-taste beverage may be a fermented beverage, in which, in the production process thereof, alcohol obtained after the removal of alcohol that is generated in a fermentation step performed using a yeast(s) (a top fermentation yeast and/or a bottom fermentation yeast) is less than 1 (v/v %). The non-alcoholic beer-taste beverage may also be a fermented beverage obtained by terminating the fermentation so that the alcohol becomes less than 1 (v/v %). Otherwise, the non-alcoholic beer-taste beverage may also be a fermented beverage obtained by dilution with water and the like so that the alcohol becomes less than 1 (v/v %). Upon termination of the fermentation, the fermentation is preferably terminated, so that off-flavors such as hydrogen sulfide, diacetyl, 2,3-pentanedione, and acetaldehyde become the threshold or less. However, it is not always necessary to set the off-flavors to be the threshold or less. If the off-flavors such as hydrogen sulfide, diacetyl, 2,3-pentanedione, and acetaldehyde are fused with the flavor of the beer-taste beverage to obtain a favorable flavor, the concentration of the off-flavors is not limited. The non-alcoholic beer-taste beverage may further be a non-fermented beverage prepared without being subjected to a fermentation step.

Moreover, the beer-taste beverage according to one embodiment of the present invention may be a fermented beer-taste beverage produced by performing a fermentation step using a yeast, or may also be anon-fermented beer-taste beverage produced without performing such a fermentation step. The fermented beer-taste beverage may be a top-fermented beer-taste beverage brewed by performing a fermentation step using a top fermentation yeast, or may also be a bottom-fermented beer-taste beverage brewed by performing a fermentation step using a bottom fermentation yeast. For such fermentation, a yeast (Saccharomyces) or a wild-type yeast (Brettanomyces, etc.), which generates alcohol, may be used. Otherwise, a yeast (Saccharomyces, etc.), a wild-type yeast (Brettanomyces, etc.), bacteria performing lactic acid fermentation or gluconic acid fermentation, and the like may also be used for fermentation.

Furthermore, the beer-taste beverage according to one embodiment of the present invention may be either an alcoholic beer-taste beverage having an alcohol percentage of 1 (v/v) % or more, or a non-alcoholic beer-taste beverage having an alcohol percentage of less than 1 (v/v) %. Besides, the non-alcoholic beer-taste beverage may be either a non-alcoholic fermented beer-taste beverage produced by performing a fermentation step and then removing alcohol generated in the fermentation step, or a non-alcoholic non-fermented beer-taste beverage prepared to have a beer-like flavor without performing a fermentation step.

In addition, the beer-taste beverage according to one embodiment of the present invention may be either a beer-taste beverage comprising a malt, in which a malt is used as a raw material, or a beer-taste beverage not comprising a malt, in which a malt is not used as a raw material. A beer-taste beverage comprising a malt is preferable, and a beer-taste beverage comprising a barley malt is more preferable.

What is more, the fermented beer-taste beverage according to one embodiment of the present invention may be either an ale beer-taste beverage brewed through a fermentation step using a top fermentation yeast, or a lager beer-taste beverage brewed through a fermentation step using a bottom fermentation yeast.

Moreover, the fermented beer-taste beverage according to one embodiment of the present invention may also be a distilled liquor-containing beer-taste beverage that contains a distilled liquor such as spirits, whiskey or shochu, and among others, a spirit-containing beer-taste beverage is preferable.

The beer-taste beverage of the present invention is a beverage, in which the amount of hops used is suppressed and the bitterness value is 18 BUs or less. In the present description, the “bitterness value” is an indicator of a bitter taste provided by iso-alpha acids such as isohumulone. The bitterness value can be measured according to the method described in “8.15 Bitterness Value” in “Revised Version Brewery Convention of Japan (BCOJ) Beer Analysis Method (2004 Nov. 1, revised edition).” Specifically, an acid is added to a degassed sample, and the obtained mixture is then extracted with isooctane. The absorbance of the obtained isooctane layer is measured at 275 nm, using isooctane as a control, and the obtained value is multiplied by a factor, so that a bitterness value (BUs) can be obtained. The bitterness value is not particularly limited, as long as it is 18 BUs or less. The bitterness value is preferably 17 BUs or less, more preferably 16 BUs or less, further preferably 15 BUs or less, still further preferably 14 BUs or less, still further preferably 13 BUs or less, still further preferably 12 BUs or less, still further preferably 11 BUs or less, still further preferably 10 BUs or less, still further preferably 9 BUs or less, still further preferably 8 BUs or less, still further preferably 7 BUs or less, still further preferably 6 BUs or less, still further preferably 5 BUs or less, still further preferably 4 BUs or less, still further preferably 3 BUs or less, still further preferably 2 BUs or less, still further preferably 1 BUs or less, still further preferably 0.5 BUs or less, and particularly preferably 0.1 BUs or less.

The bitterness value depends on the content of iso-alpha acid in a beverage, and the iso-alpha acid is a bitter taste component contained in a large amount in hops. Accordingly, by controlling the amount of hops used, a beverage having a predetermined bitterness value can be produced.

The bitterness value can be controlled by adjusting the variety of hops, the amount of hops used, the timing of addition of hops, the temperature upon addition of hops and the retention time in the temperature range, pH upon addition of hops, the concentration of an original extract in a pre-fermentation solution, the concentration of an original extract in a fermentation step, fermentation conditions (oxygen concentration, aeration conditions, the variety of the yeast, the additive amount of the yeast, the number of proliferating yeast cells, the timing of removing the yeast, fermentation temperature, fermentation time, pressure setting, carbon dioxide concentration, etc.) and the like, conditions for beer filtration, addition of a dilution water, addition of carbonated water, and the like. Moreover, the bitterness value can also be adjusted using a commercially available hop processed product (iso-alpha acid, etc.) and the like, and the bitterness value can be controlled by adjusting the amount of such a commercially available hop processed product, the type of such a commercially available hop processed product, the timing of addition thereof, the temperature upon addition thereof and the retention time in the temperature range, pH upon addition thereof, the concentration of an original extract in a pre-fermentation solution, the concentration of an original extract in a fermentation step, fermentation conditions (oxygen concentration, aeration conditions, the variety of the yeast, the additive amount of the yeast, the number of proliferating yeast cells, the timing of removing the yeast, fermentation temperature, fermentation time, pressure setting, carbon dioxide concentration, etc.) and the like, conditions for beer filtration, addition of a dilution water, addition of carbonated water, and the like. As such hops, pelletized hops prepared by pelletizing hops may be used, or hop extracts prepared by processing hops into the form of extracts may also be used. Otherwise, hop bracts may also be used. Such hops and hop processed products may be used alone, or may also be used in combination.

Furthermore, a beverage that does not substantially contain components derived from hops can be produced without using hops as raw materials.

There are some beer-taste beverages of not using hops, in which a tight feeling is insufficient and thus, a flavor becomes weak. The beer-taste beverage of the present invention is such a beverage in which the amount of hops used is suppressed, so that the bitterness value becomes 18 BUs or less. However, by adjusting the total nitrogen amount to be 5 to 140 mg/100 mL, the total polyphenol amount to be 3 to 200 ppm by mass, and the content of 2,3-diethyl-5-methylpyrazine to be 0.02 ppb by mass or more, the beer-taste beverage of the present invention can become a beer-taste beverage having a flavor suitable for beer-taste beverages and a tight feeling suitable for beer-taste beverages.

The total nitrogen amount in the beer-taste beverage of the present invention is 5 to 140 mg/100 mL. The “total nitrogen amount” in the present invention is the total amount of all nitrogen compounds including proteins, amino acid, and the like.

The total nitrogen amount influences on a tight feeling, the satisfying quality of a beverage, the thickness of a taste, a flavor, etc. By setting the total nitrogen amount to be 5 mg/100 mL or more, a tight feeling, the satisfying quality of a beverage, the thickness of a taste, and a flavor can be improved. From the viewpoint of further improving these factors, the total nitrogen amount in the beer-taste beverage of the present invention is preferably 10 mg/100 mL or more, more preferably 15 mg/100 mL or more, further preferably 20 mg/100 mL or more, still further preferably 25 mg/100 mL or more, and particularly preferably 30 mg/100 mL or more.

On the other hand, if the total nitrogen amount is large, the taste of the beverage becomes heavy. Thus, by setting the total nitrogen amount in the beverage of the present invention to be 140 mg/100 mL or less, the taste can be lightened. From the viewpoint of further improving the taste of the beverage, the total nitrogen amount is preferably 130 mg/100 mL or less, more preferably 125 mg/100 mL or less, further preferably 120 mg/100 mL or less, still further preferably 115 mg/100 mL or less, still further preferably 110 mg/100 mL or less, and particularly preferably 105 mg/100 mL or less.

The total nitrogen amount in the carbonated beverage of the present invention can be adjusted by determining, as appropriate, addition of a diluting solution or carbonated water, the types of raw materials (malts, corn grits, a sugar solution, etc.), the amounts of the raw materials, the type of an enzyme, the additive amount of the enzyme (including a proteolytic enzyme, etc.), the temperature applied upon an enzymatic reaction, the timing of adding the enzyme, the proteolysis time in a preparation tank, the pH in the preparation tank, the temperature in the preparation tank, the pH in a preparation step (a wort-producing step from addition of the malts until addition of the yeast), the temperature applied in the preparation step, and filtration conditions, such as the temperature upon filtration of a wort, the time for wort filtration, the pH applied upon wort filtration, the amount of sparging water used upon wort filtration, the preset temperature in each temperature range and retention time during preparation of a wort, the boiling time and pH in a boiling step, the concentration of an original extract in a pre-fermentation solution, the concentration of an original extract in a fermentation step, fermentation conditions (an oxygen concentration, aeration conditions, the variety of the yeast, the additive amount of the yeast, the number of proliferating yeast cells, the timing of removing the yeast, a fermentation temperature, a fermentation time, pressure setting, a carbon dioxide concentration, etc.), and the like.

When beer brewing equipment such as a preparation tank or a fermentation tank is not used, the total nitrogen amount can be adjusted by determining, as appropriate, the time applied in the production step (a preparation time attended with the mixing of raw materials, etc.), the temperature applied in the production step, the pH applied in the production step, the concentration of an original extract in the production step, etc., as well as addition of a dilution solution or carbonated water, and selection of the used amounts or types of raw materials.

For example, the total nitrogen amount in the beer-taste beverage of the present invention can be controlled by adjusting the used amounts of raw materials, in which the nitrogen content is relatively high and which can be assimilated by yeasts. Specifically, by increasing the used amount of malts having a high content of nitrogen, the total nitrogen amount can be increased. Examples of such raw materials having a high content of nitrogen may include malts, soybeans, yeast extracts, peas, ungerminated grains, collagens, collagen peptides, and yeast extracts. Examples of the ungerminated grains may include ungerminated barley, wheat, rye, wild oats, oats, adlay, Avena sativa, soybeans, and peas.

The total nitrogen amount in the beer-taste beverage according to the present invention can be measured, for example, by the method described in “8.9 Total nitrogen” in “Revised Version Brewery Convention of Japan (BCOJ) Beer Analysis Method (published by the Brewing Society of Japan, edited by Brewers Association of Japan, Brewery Convention of Japan [Analysis Committee], and enlarged and revised in 2013).”

The total polyphenol amount in the beer-taste beverage of the present invention is 3 to 200 ppm by mass.

Polyphenol is a compound in which two or more hydrogens of aromatic hydrocarbon are substituted with hydroxyl groups. Examples of such polyphenol may include flavonol, isoflavone, tannin, catechin, quercetin, and anthocyanin.

The “total polyphenol amount” in the present invention is the total amount of polyphenols contained in the beer-taste beverage.

The total polyphenol amount influences on the satisfying quality of a beverage, the thickness of a taste, a flavor, etc. By setting the total polyphenol amount to be 3 ppm by mass or more, a tight feeling, the satisfying quality of a beverage, the thickness of a taste, and a flavor can be improved. From the viewpoint of further improving these factors, the total polyphenol amount in the beer-taste beverage of the present invention is preferably 4 ppm by mass or more, more preferably 7 ppm by mass or more, further preferably 10 ppm by mass or more, still further preferably 15 ppm by mass or more, still further preferably 20 ppm by mass or more, still further preferably 25 ppm by mass or more, and particularly preferably 30 ppm by mass or more.

On the other hand, in the case of a beverage in which the total polyphenol amount is large, turbidity stability decreases, and also, the taste of the beverage becomes heavy. Thus, by setting the total polyphenol amount in the beverage of the present invention to be 200 ppm by mass or less, the turbidity stability and taste of the beverage can be improved. From the viewpoint of further improving these factors, the total polyphenol amount is preferably 190 ppm by mass or less, more preferably 180 ppm by mass or less, further preferably 170 ppm by mass or less, and particularly preferably 163 ppm by mass or less.

The total polyphenol amount in the beer-taste beverage of the present invention can be adjusted by determining, as appropriate, addition of a diluting solution or carbonated water, the types of raw materials (raw materials containing polyphenol, such as malts), the amounts of the raw materials, the type of an enzyme, the additive amount of the enzyme, the timing of adding the enzyme, the pH in a preparation tank, the pH in a preparation step (a wort-producing step from addition of the malts until addition of the yeast), the time for wort filtration, the preset temperature in each temperature range and retention time during preparation of a wort (including during saccharification), the concentration of an original extract in a pre-fermentation solution, the concentration of an original extract in a fermentation step, fermentation conditions (an oxygen concentration, aeration conditions, the variety of the yeast, the additive amount of the yeast, the number of proliferating yeast cells, the timing of removing the yeast, a fermentation temperature, a fermentation time, pressure setting, a carbon dioxide concentration, etc.), and the like.

When beer brewing equipment such as a preparation tank or a fermentation tank is not used, the total polyphenol amount can be adjusted by determining, as appropriate, the time applied in the production step (a preparation time attended with the mixing of raw materials, etc.), the temperature applied in the production step, the pH applied in the production step, the concentration of an original extract in the production step, etc., as well as addition of a dilution solution or carbonated water, and selection of the used amounts or types of raw materials.

Moreover, the total polyphenol amount in the carbonated beverage of the present invention can be controlled by adjusting the used amounts of raw materials in which the polyphenol content is high, including, for example, grain raw materials such as barley malts or the husks (rhytidomes) of malts, tea raw materials such as green tea, barley tea, black tea or oolong tea, coffee raw materials such as coffee beans, and other raw materials such as pericarps, fruits or seeds. Specifically, the total polyphenol amount can be increased by increasing the used amounts of raw materials in which the polyphenol content is high, such as malts.

In general, in malts having husks (rhytidomes) and the like, the contents of nitrogen and polyphenol are high. On the other hand, in soybeans, yeast extracts, wheats, wheat malts and the like, the content of nitrogen is high, but the content of polyphenol is low. Hence, by adjusting the mixing ratio of raw materials, the total nitrogen amount and the total polyphenol amount in the beer-taste beverage can be increased or decreased. Representative methods (1) to (4) of increasing or decreasing the total nitrogen amount and the total polyphenol amount are as described below.
(1) The total nitrogen amount and the total polyphenol amount in the beer-taste beverage are increased by increasing the used amounts of malts having husks and the like.
(2) By increasing or decreasing the used amounts of soybeans, yeast extracts and the like, the total nitrogen amount in the beer-taste beverage is increased or decreased, while maintaining the total polyphenol amount.
(3) By increasing the used amounts of malts having husks and the like, and also by decreasing the used amounts of soybeans, yeast extracts and the like, the total polyphenol amount is increased, while maintaining the total nitrogen amount.
(4) By decreasing the used amounts of malts having husks and the like, and also by increasing the used amounts of soybeans, yeast extracts and the like, the total polyphenol amount is decreased, while maintaining the total nitrogen amount.

The total polyphenol amount in the beer-taste beverage of the present invention can be measured, for example, by the method described in “8.19 Total Polyphenol” in “Revised Version Brewery Convention of Japan (BCOJ) Beer Analysis Method (published by the Brewing Society of Japan, edited by Brewers Association of Japan, Brewery Convention of Japan [Analysis Committee], and enlarged and revised in 2013).”

From the viewpoint of imparting a light taste to the beer-taste beverage of the present invention while suppressing the wateriness thereof, the ratio between the total nitrogen amount and the total polyphenol amount, namely, the total nitrogen amount (mg/100 mL)/the total polyphenol amount (ppm by mass) is preferably 0.2 to 3.0, more preferably 0.25 to 2.8, further preferably 0.3 to 2.7, still further preferably 0.35 to 2.6, still further preferably 0.4 to 2.5, and particularly preferably 0.5 to 2.4.

Besides, the total nitrogen amount (mg/100 mL)/the total polyphenol amount (ppm by mass) may be set to be 0.55 or more, 0.6 or more, 0.65 or more, 0.7 or more, 0.75 or more, or 0.8 or more. On the other hand, it may also be set to be 2.2 or less, 2.0 or less, 1.8 or less, 1.5 or less, 1.2 or less, or 1.0 or less.

From the viewpoint of imparting a more improved flavor suitable for beer-taste beverages to the beer-taste beverage of the present invention, at least a portion of nitrogen or polyphenol is preferably derived from malts.

Moreover, from the viewpoint of imparting a more improved tight feeling suitable for beer-taste beverages to the beer-taste beverage of the present invention, at least a portion of nitrogen or polyphenol is preferably derived from coms.

That is to say, from the viewpoint of achieving a beverage, in which both a flavor and a tight feeling suitable for beer-taste beverages are further improved, at least a portion of nitrogen or polyphenol is preferably derived from malts and derived from coms.

The beer-taste beverage of the present invention comprises 2,3-diethyl-5-methylpyrazine, and the content of the 2,3-diethyl-5-methylpyrazine is 0.02 ppb by mass or more.

Since 2,3-diethyl-5-methylpyrazine gives to a beverage, a flavor and a tight feeling suitable for beer-taste beverages, it can effectively improve a flavor and a tight feeling in a beer-taste beverage with a suppressed bitterness value. In particular, a specific bitterness derived from hops is hardly felt from a beer-taste beverage having a bitterness value of 18 Bus or less, and a malt flavor is significantly felt from a beer-taste beverage, in which the total nitrogen amount and the total polyphenol amount are comprised at certain values or more. Thus, when such a beer-taste beverage comprises a certain amount of 2,3-diethyl-5-methylpyrazine, a flavor and a tight feeling suitable for beer-taste beverages can be effectively imparted to the beer-taste beverage. Hence, the content of 2,3-diethyl-5-methylpyrazine in the beer-taste beverage of the present invention is preferably 0.05 ppb by mass or more, more preferably 0.1 ppb by mass or more, further preferably 0.2 ppb by mass or more, still further preferably 0.3 ppb by mass or more, still further preferably 0.4 ppb by mass or more, still further preferably 0.5 ppb by mass or more, still further preferably 0.6 ppb by mass or more, still further preferably 0.7 ppb by mass or more, still further preferably 0.8 ppb by mass or more, still further preferably 0.9 ppb by mass or more, and particularly preferably 1.0 ppb by mass or more.

On the other hand, from the viewpoint of achieving a beverage having a tight feeling suitable for beer-taste beverages, the content of 2,3-diethyl-5-methylpyrazine in the beverage of the present invention is preferably 100 ppb by mass or less, more preferably 80 ppb by mass or less, further preferably 70 ppb by mass or less, still further preferably 60 ppb by mass or less, still further preferably 50 ppb by mass or less, still further preferably 40 ppb by mass or less, and particularly preferably 30 ppb by mass or less.

The content of 2,3-diethyl-5-methylpyrazine in the beer-taste beverage of the present invention can be controlled by, for example, adding 2,3-diethyl-5-methylpyrazine or adjusting the amount of raw materials used, having a high content of 2,3-diethyl-5-methylpyrazine.

The content of 2,3-diethyl-5-methylpyrazine in the beer-taste beverage of the present invention can be measured by gas chromatography-mass spectrometry (m/z 135).

The beer-taste beverage of the present invention includes a non-alcoholic beer-taste beverage. The alcohol percentage in the beer-taste beverage of the present invention is not particularly limited, and it is preferably 0 to 20.0 (v/v) %, more preferably 0.5 to 17.0 (v/v) %, further preferably 1.0 to 15.0 (v/v) %, still further preferably 2.0 to 12.0 (v/v) %, still further preferably 3.0 to 10.0 (v/v) %, and particularly preferably 4.0 to 9.0 (v/v) %.

Besides, in the present description, the alcohol percentage is indicated with the percentage (v/v) % of volume/volume basis. In addition, the content of alcohol in a beverage can be measured by all of known methods, and it can be measured, for example, using an oscillatory density meter.

Moreover, the beer-taste beverage according to one embodiment of the present invention may further comprise, as alcohol components, spirits derived from grains.

In the present description, the spirits mean alcohols obtained by using, as raw materials, grains such as mugi, rice, buckwheat or com, saccharifying the raw material grains using malts, or as necessary, an enzyme agent, then fermenting the resultants using yeasts, and then, further distilling the fermented products. The grain as a raw material of spirits is preferably mugi.

The color of the beer-taste beverage according to one embodiment of the present invention is not particularly limited. The beer-taste beverage according to one embodiment of the present invention may have an amber or golden color, such as those of common beer, or may have a black color such as that of black beer, or may also be colorless and transparent. Otherwise, a desired color may be imparted to the beer-taste beverage by adding a coloring agent or the like thereto. The color of the beverage can be determined with the unaided eye, but it may also be determined using total light transmittance, chromaticity, etc.

The pH of the beer-taste beverage according to one embodiment of the present invention is not particularly limited, and it is preferably pH 2.0 to 4.6, more preferably pH 2.5 to 4.5, further preferably pH 3.0 to 4.2, and particularly preferably pH 3.2 to 4.0. The pH of the beer-taste beverage is preferably pH 4.5 or less, more preferably pH 4.3 or less, further preferably pH 4.2 or less, still further preferably pH 4.1 or less, still further preferably pH 4.0 or less, still further preferably pH 3.9 or less, still further preferably pH 3.8 or less, and particularly preferably pH 3.7 or less. In addition, when the pH of the beer-taste beverage of the present invention is pH 2.0 or more, the flavor of the beverage is easily improved, and the pH of the present beer-taste beverage is preferably pH 2.2 or more, more preferably pH 2.2 or more, further preferably pH 2.5 or more, still further preferably pH 2.7 or more, and particularly preferably pH 3.0 or more.

The pH of an alcoholic beer-taste beverage is preferably pH 3.0 to 4.5, more preferably pH 3.3 to 4.3, and particularly preferably pH 3.5 to 4.0. On the other hand, the pH of anon-alcoholic beer-taste beverage is preferably pH 3.0 to 4.5, more preferably pH 3.0 to 4.0, and particularly preferably pH 3.2 to 3.8.

The pH of the beer-taste beverage can be adjusted by determining, as appropriate, addition of a diluting solution or carbonated water, the types of raw materials (malts, corn grits, a sugar solution, etc.), the amounts of the raw materials, the type of an enzyme, the additive amount of the enzyme, the timing of adding the enzyme, the saccharification time in a preparation tank, the proteolysis time in the preparation tank, the pH in the preparation tank, the pH in a preparation step (a wort-producing step from addition of the malts until addition of the yeast), the type of an acid used upon the pH adjustment (lactic acid, phosphoric acid, malic acid, tartaric acid, citric acid, etc.), the additive amount of an acid used upon the pH adjustment, the timing of the pH adjustment (at the time of preparation, during fermentation, at completion of the fermentation, before beer filtration, after beer filtration, etc.), the preset temperature in each temperature range and retention time during preparation of a wort (including during saccharification), the concentration of an original extract in a pre-fermentation solution, the concentration of an original extract in a fermentation step, fermentation conditions (oxygen concentration, aeration conditions, the variety of the yeast, the additive amount of the yeast, the number of proliferating yeast cells, the timing of removing the yeast, fermentation temperature, fermentation time, pressure setting, carbon dioxide concentration, etc.), and the like.

When beer brewing equipment such as a preparation tank or a fermentation tank is not used, pH can be adjusted by determining, as appropriate, the time applied in the production step (a preparation time attended with the mixing of raw materials, etc.), the temperature applied in the production step, the pH applied in the production step, the concentration of an original extract in the production step, etc., as well as addition of a diluting solution or carbonated water, addition of minerals (sodium, salts, potassium salts, calcium salts, magnesium salts, etc.), addition of water containing minerals, and selection of the used amount or type of an acidulant and the used amounts or types of raw materials.

The pH of the carbonated beverage according to the present invention can be measured by the method described in “8.7 pH” in “Revised Version Brewery Convention of Japan (BCOJ) Beer Analysis Method (published by the Brewing Society of Japan, edited by Brewers Association of Japan, Brewery Convention of Japan [Analysis Committee], and enlarged and revised in 2013).”

The original wort extract (0-Ex) concentration in the beer-taste beverage according to one embodiment of the present invention is not particularly limited. From the viewpoint of imparting a light taste to the beer-taste beverage, the original wort extract (0-Ex) concentration in the alcoholic beer-taste beverage is preferably 5% to 18% by mass, more preferably 8% to 15% by mass, further preferably 9% to 14% by mass, and particularly preferably 10% to 13.5% by mass.

The “original wort extract concentration” in the present description means, in the case of a beverage having an alcohol percentage of 1 (v/v) % or more, an extracted component according to the Japanese Liquor Tax Law, namely, nonvolatile components in grams contained in 100 cm³ of an original volume at a temperature of 15° C. On the other hand, in the case of a beverage having an alcohol percentage of less than 1 (v/v) %, the original wort extract concentration means an extract value (% by mass) that is obtained by measuring a degassed sample according to an analysis method defined by Brewers Association of Japan, Brewery Convention of Japan (BCOJ) (BCOJ Beer Analysis Method (published by the Brewing Society of Japan, edited by Brewers Association of Japan, revised on Nov. 1, 2004)).

The beer-taste beverage according to one embodiment of the present invention is suitable for the embodiment of being packed in a container. Examples of the container may include bottles, plastic bottles, cans, and barrels. In particular, from the viewpoint of the ease of carrying, cans, bottles and plastic bottles are preferable.

Besides, when a colorless transparent bottle or plastic bottle is used, differing from the case of an ordinary can or a colored bottle, the beverage contained in the container is exposed to sunlight or fluorescent light. However, since the beer-taste beverage according to one embodiment of the present invention does not substantially contain components derived from hops, generation of a sun flavor caused by irradiation with a sunlight is suppressed. Thus, the beer-taste beverage according to one embodiment of the present invention can be filled into such a colorless transparent bottle or plastic bottle.

Grains that can be used in the production of the beer-taste beverage of the present invention and optional additive raw materials such as sweeteners will be described in detail in the following “1.1 Raw materials.”

### 1.1 Raw Materials

As main raw materials of the non-alcoholic beer-taste beverage according to one embodiment of the present invention, malts may be or may not be used together with water. In addition, hops may also be used, and further, a preservative, a sweetener, water-soluble dietary fibers, a bittering agent or a bitterness-imparting agent, an antioxidant, a flavor, an acidulant, salts, and the like may also be used.

When malts are used as raw materials, the malts mean those obtained by germinating the seeds of mugi plants such as barley, wheat, rye, wild oats, oats, adlay, or Avena sativa, then drying them, and then removing roots. The production area and variety of the used malts are not particularly limited. In the present invention, barley malts are preferably used. The barley malts are one type of malts that are most commonly used as raw materials of beer-taste beverages in Japan. Barley has several types such as two-row barley and six-row barley. All types of barley may be used. Further, in addition to common malts, colored malts and the like can also be used. When such colored malts are used, different types of colored malts may be appropriately used in combination, or only one type of colored malts may also be used.

Moreover, together with such malts, grains other than the malts, proteins, yeast extracts, sugar solutions, and the like may also be used. Examples of such grains may include mugi that does not correspond to malts (e.g. barley, wheat, rye, wild oats, oats, adlay, Avena sativa, etc.), rice (e.g. white rice, brown rice, etc.), coms (e.g. corn grits, etc.), kaoliang, potato, beans (e.g. soybeans, garden peas, etc.), buckwheat, sorghum, foxtail millet, barnyard millet, starches obtained from these grains, and extracts thereof. Among these, coms (e.g. corn grits, etc.) are preferably used. In addition, examples of the proteins may include soybean proteins, pea proteins, yeast extracts, and decomposition products thereof.

Besides, when malts are not used, a beer-taste beverage, comprising liquid sugar containing a carbon source, and a nitrogen source serving as an amino acid-containing material (e.g. soybean proteins, etc.) of the aforementioned grains other than malts, may be applied.

Malts contain a nitrogen compound and polyphenol. Accordingly, in the present invention, in order to adjust the total nitrogen amount and the total polyphenol amount in the beer-taste beverage of the present invention to be within a certain ranges specified in the present invention, the percentage of the malts in the raw materials is preferably set to be in a certain range. Specifically, the percentage of the malts used (the percentage of all malts used) is preferably 1% by mass or more, more preferably 3% by mass or more, and further preferably 4% by mass or more. By setting the percentage of the malts used to be within the above-described range, a beer-taste beverage having a flavor suitable for beers derived from malts can be produced. In addition, the percentage of the malts used in the beer-taste beverage of the present invention may also be 10% by mass or more, 20% by mass or more, or 30% by mass or more.

On the other hand, the percentage of the malts used in the beer-taste beverage of the present invention is preferably 90% by mass or less, more preferably 80% by mass or less, and further preferably 75% by mass or less. In addition, the percentage of the malts used in the beer-taste beverage of the present invention may also be 65% by mass or less, 60% by mass or less, 55% by mass or less, or 50% by mass or less.

In the present description, the percentage of the malts used means a value calculated in accordance with the Notification of the Interpretation of the Liquor Tax Law and Other Laws and Orders relating to the Administration of Liquor Affairs (date of enforcement: Apr. 1, 2018).

When the percentage of the malts is suppressed, it is preferable to increase the amounts of raw materials other than the malts, which can be assimilated by yeasts (i.e. a carbon source and a nitrogen source). Examples of the carbon source as a raw material, which can be assimilated by yeasts, may include monosaccharide, disaccharide, trisaccharide, and sugar solutions thereof. Examples of the nitrogen source as a raw material, which can be assimilated by yeasts, may include yeast extracts, soybean proteins, malts, soybeans, yeast extracts, peas, wheat malts, ungerminated grains, and decomposition products thereof. Examples of the ungerminated grains may include ungerminated barley, wheat, rye, wild oats, oats, adlay, Avena sativa, soybeans, and peas. In particular, if sugars are used as raw materials, a malt-derived mugi flavor can be effectively suppressed.

As 2,3-diethyl-5-methylpyrazine comprised in the beer-taste beverage according to one embodiment of the present invention, 2,3-diethyl-5-methylpyrazine comprised in the raw materials may be utilized, or 2,3-diethyl-5-methylpyrazine or an additive containing 2,3-diethyl-5-methylpyrazine may be added. Otherwise, in the case of production by a brewing process, the generated 2,3-diethyl-5-methylpyrazine may be utilized.

Examples of the forms of hops used in one embodiment of the present invention may include pelletized hops, powdered hops, and hop extracts. In addition, the used hops may also be hop-processed products such as isomerized hops and reduced hops.

Examples of the preservative used herein may include: benzoic acid; benzoates such as sodium benzoate; benzoic acid esters such as propyl parahydroxy-benzoate and butyl parahydroxy-benzoate; and dimethyl dicarbonate. Moreover, as such preservatives, commercially available preparations, such as Strong SANPRESER (manufactured by San-Ei Gen F.F.I., Inc.; a mixture of sodium benzoate and butyl benzoate), may also be used. These preservatives may be used alone or may also be used in combination of two or more types.

The mixed amount of such a preservative is preferably 5 to 1200 ppm by mass, more preferably 10 to 1100 ppm by mass, further preferably 15 to 1000 ppm by mass, and still further preferably 20 to 900 ppm by mass.

Examples of the sweetener used herein may include commercially available saccharified solution obtained by decomposing grain-derived starch with an acid, an enzyme or the like, commercially available sugars such as starch syrup, sugar that is trisaccharide or more, sugar alcohol, natural sweeteners such as stevia, and artificial sweeteners.

The form of these sugars may be either a liquid such as a solution, or a solid such as powders.

Moreover, the types of raw material grains for starch, the method of purifying starch, and treatment conditions, such as hydrolysis with an enzyme or an acid, are not particularly limited. For example, conditions for hydrolysis with an enzyme or an acid are determined, as appropriate, so that sugars in which the ratio of maltose is increased may be used. Furthermore, sucrose, fructose, glucose, maltose, trehalose, maltotriose, a solution thereof (i.e. a sugar solution) and the like can also be used.

Further, examples of the artificial sweetener may include aspartame, acesulfame potassium (acesulfame K), sucralose, and neotame.

Examples of the water-soluble dietary fibers may include indigestible dextrin, polydextrose, partially hydrolyzed guar gum, pectin, glucomannan, alginic acid, laminarin, fucoidin, and carrageenan. From the viewpoint of versatility such as stability and safety, indigestible dextrin or polydextrose is preferable.

The bittering agent or the bitterness-imparting agent used in a bitterness value range of 18 BUS or less is not particularly limited. In addition to hops, examples of the bittering agent or the bitterness-imparting agent may include Ganoderma lucidum, Litchi chinensis, Carum carvim, juniper fruit, sage, rosemary, reishi mushroom, laurel, quasin, citrus extract, Picrasma quassioides extract, coffee extract, tea extract, bitter melon extract, lotus germ extract, Aloe arborescens extract, Ganoderma lucidum extract, Litchi chinensis extract, laurel extract, sage extract, caraway extract, naringin, Artemisia absinthium, and Artemisia absinthium extract.

The antioxidant is not particularly limited, and the substances used as antioxidants in a common beer or a low-malt beer can be used. Examples thereof may include ascorbic acid, erythorbic acid, and catechin.

The flavor is not particularly limited, and a common beer flavor can be used. Such a beer flavor is used to add a beer-like flavor to beverages, and the beer flavor contains brewed components generated by fermentation, and the like. Specific examples of the beer flavor may include esters and higher alcohols. Further specific examples of the beer flavor may include isoamyl acetate, ethyl acetate, n-propanol, isobutanol, acetaldehyde, ethyl caproate, linalool, 4-vinylguaiacol, isoamyl propionate, 2-methyl-2-pentenoic acid, 4-methyl-3-pentenoic acid, methional, furfural, and furaneol.

These flavors may be used alone, or may also be used in combination of two or more types.

The acidulant is not particularly limited, as long as it is a substance having a sourness. Examples of such an acidulant may include tartaric acid, phosphoric acid, citric acid, gluconic acid, lactic acid, malic acid, phytic acid, acetic acid, succinic acid, glucono delta lactone, and salts thereof.

Among these acidulants, tartaric acid, phosphoric acid, citric acid, gluconic acid, lactic acid, malic acid, phytic acid, acetic acid, succinic acid, and salts thereof are preferable; and tartanc acid, phosphoric acid, citric acid, lactic acid, acetic acid, and salts thereof are more preferable.

These acidulants may be used alone, or may also be used in combination of two or more types.

### 1.2 Carbon Dioxide Gas

As carbon dioxide gas contained in the beer-taste beverage according to one embodiment of the present invention, carbon dioxide gas contained in the raw materials may be utilized, or carbon dioxide gas may be dissolved in the beverage by the mixing of the beverage with carbonated water, addition of carbon dioxide gas to the beverage, and the like.

Since the beer-taste beverage according to one embodiment of the present invention is produced by alcoholic fermentation, carbon dioxide gas generated during the fermentation step may be used as is. Otherwise, carbonated water is added, as appropriate, so that the amount of carbon dioxide gas may be adjusted.

The concentration of carbon dioxide gas in the beer-taste beverage according to one embodiment of the present invention is preferably 0.30 (w/w) % or more, more preferably 0.35 (w/w) % or more, even more preferably 0.40 (w/w) % or more, further preferably 0.42 (w/w) % or more, still further preferably 0.45 (w/w) % or more, still further preferably 0.46 (w/w) % or more, still further preferably 0.47 (w/w) % or more, and particularly preferably 0.48 (w/w) % or more. On the other hand, the concentration of carbon dioxide gas in the beer-taste beverage according to one embodiment of the present invention is preferably 0.80 (w/w) % or less, more preferably 0.70 (w/w) % or less, even more preferably 0.65 (w/w) % or less, further preferably 0.60 (w/w) % or less, still further preferably 0.59 (w/w) % or less, still further preferably 0.58 (w/w) % or less, still further preferably 0.57 (w/w) % or less, still further preferably 0.56 (w/w) % or less, and particularly preferably 0.55 (w/w) % or less.

Besides, in the present description, the concentration of the carbon dioxide gas can be measured by immersing a container containing the beverage as a target in a water tank at 20° C. for 30 minutes or more, while shaking the container sometimes, so that the temperature of the beverage is adjusted to 20° C., and then measuring the carbon dioxide gas concentration using a gas volume measuring device (for example, GVA-500 (manufactured by KYOTO ELECTRONICS MANUFACTURING CO., LTD.), etc.).

The amount of the carbon dioxide gas contained in the beer-taste beverage according to one embodiment of the present invention is indicated with the carbon dioxide gas pressure of the beverage. The carbon dioxide gas pressure of the beverage is not particularly limited, as long as it does not impair the effects of the present invention. Typically, the upper limit of the carbon dioxide gas pressure of the beverage is 5.0 kg/cm², 4.5 kg/cm², or 4.0 kg/cm², and the lower limit thereof is 0.20 kg/cm², 0.50 kg/cm², or 1.0 kg/cm². These upper limits and lower limits may be combined with one another in any ways. For example, the carbon dioxide gas pressure of the beverage may be 0.20 kg/cm² or more and 5.0 kg/cm² or less, 0.50 kg/cm² or more and 4.5 kg/cm² or less, or 1.0 kg/cm² or more and 4.0 kg/cm² or less. On the other hand, the amount of the carbon dioxide gas contained in the container-packed carbonated beverage according to one embodiment of the present invention may be set to be 5.0 kg/cm² or less, 4.5 kg/cm² or less, or 4.0 kg/cm² or less, or may also be set to be 0.20 kg/cm² or more, 0.50 kg/cm² or more, or 1.0 kg/cm² or more. Besides, these upper limits and lower limits may be combined with one another in any ways, and for example, the carbon dioxide gas pressure of the beverage may be 0.20 kg/cm² or more and 5.0 kg/cm² or less, 0.50 kg/cm² or more and 4.5 kg/cm² or less, or 1.0 kg/cm² or more and 4.0 kg/cm² or less.

In the present description, the gas pressure means a gas pressure in a container, unless otherwise specified.

The pressure can be measured by a method well known to those skilled in the art, and for example, the pressure can be measured by applying a method comprising fixing a sample set at 20° C. in a gas pressure gauge, then once opening the stopper cock of the gas pressure gauge to discharge gas, then closing the stopper cock again, then shaking the gas pressure gauge, and then reading the value when the indicator reaches a predetermined position, or by using a commercially available gas pressure measurement device.

### 1.3 Other Additives

The beer-taste beverage according to one embodiment of the present invention may comprise various additives, as necessary, in a range in which the additives do not impair the effects of the present invention.

Examples of such additives may include coloring agents, foaming agents, fermentation promoters, yeast extracts, protein substances such as peptide-containing matters, and condiments such as amino acids.

The coloring agent is used to impart a beer-like color to the beverage, and a caramel coloring or the like can be used. The foaming agent is used to form beer-like foams for the beverage, or to retain the foams of the beverage. Examples of the foaming agent that can be appropriately used herein may include: plant-extracted saponin substances such as soybean saponin and quillaja saponin; vegetable proteins of coms, soybeans, and the like; peptide-containing matters such as collagen peptides; and yeast extracts.

The fermentation promoter is used to promote fermentation with yeasts. For example, yeast extracts, bran ingredients of rice, mugi, and the like, vitamins, and mineral agents can be used alone or in combination.

### 1.4 Container-Packed Beverage

The beer-taste beverage according to one embodiment of the present invention may be a container-packed beverage that is contained in a container. For the container-packed beverage, containers having any forms and/or being made of any materials may be used, and examples of the container may include bottles, cans, barrels, and plastic bottles. In particular, from the viewpoint of the ease of carrying, cans, bottles and plastic bottles are preferable.

### 2.1 Method for Producing Fermented Beer-Taste Beverage

The method for producing the beer-taste beverage according to one embodiment of the present invention is not particularly limited, and it is preferably a method comprising a step of adding a yeast to water and raw materials that can be assimilated by the yeast and performing alcoholic fermentation.

The raw materials that can be assimilated by the yeast are as described in the aforementioned section about raw materials, and the raw materials preferably comprise malts and corns.

Moreover, the method for producing the beer-taste beverage according to one embodiment of the present invention is preferably a method having the following Step (1). More preferably, the method for producing the beer-taste beverage according to one embodiment of the present invention further comprises Step (4) of adjusting the content of 2,3-diethyl-5-methylpyrazine, and the present production method may further comprise Step (2) of mixing one or more types of raw materials that can be assimilated by the yeast into the raw material mixture, and Step (3) of adding spirits derived from grains to the raw material mixture.
Step (1): a step of adding a yeast to water and raw materials comprising malts and performing alcoholic fermentation.
Step (2): a step of mixing one or more types of raw materials that can be assimilated by the yeast into the raw material mixture.
Step (3): a step of adding spirits derived from grains to the raw material mixture.
Step (4): a step of adjusting the content of 2,3-diethyl-5-methylpyrazine.

The order of performing the above-described Steps (1) to (4) is not particularly limited. It is preferable that water and malts are mixed with raw materials that can be assimilated by the yeast, as Step (2), so as to prepare a raw material before fermentation, and that alcoholic fermentation is then performed on the raw material comprising the raw materials that can be assimilated by the yeast, as Step (1).

In addition, regarding Step (3) as well, the order of performing individual steps is not particularly limited, and for example, the mixing of individual components performed in Step (3) may be carried out on the raw material before fermentation, prior to Step (1), or the mixing of individual components performed in Step (3) may also be carried out on the raw material after fermentation, after completion of Step (1).

Regarding Step (4) as well, the order of performing individual steps is not particularly limited, and for example, the adjustment of the content of 2,3-diethyl-5-methylpyrazine performed in Step (4) may be carried out on the raw material after fermentation, after completion of Step (1). However, Step (4) is preferably carried out as a last step. Specifically, it is preferable that a beer-taste base beverage is produced based on the steps other than Step (4) (e.g. Steps (1) to (3)), and that the content of 2,3-diethyl-5-methylpyrazine in the base beverage is adjusted based on Step (4).

In the production method of the present invention, the yeast is preferably removed by a filtration step. The order of performing such a filtration step is not particularly limited, and the filtration step is preferably carried out between Step (2) and Step (3).

Moreover, in the production method of the present invention, the bitterness value is 18 BUs or less, and the amount of hops used is limited. A beverage, in which the amount of hops having bacteriostatic effects used is limited, has a risk of generation and proliferation of microorganisms. Thus, in order to suppress such generation and proliferation of microorganisms, the production method of the present invention preferably has a sterilization step. The order of performing such a sterilization step is not particularly limited, and the sterilization step is preferably carried out after completion of Step (4). The sterilization step is preferably carried out by heating.

The percentage of malt used in the method for producing the beer-taste beverage according to one embodiment of the present invention is not particularly limited, and it may be 10% by mass or more, 20% by mass or more, or 30% by mass or more. On the other hand, the percentage of malts used in the present production method is preferably 90% by mass or less, more preferably 80% by mass or less, and further preferably 75% by mass or less, and it may also be 65% by mass or less, 60% by mass or less, 55% by mass or less, or 50% by mass or less.

### <Step (1)>

Step (1) is a step of adding a yeast to water and raw materials comprising malts and performing alcoholic fermentation.

As a method of preparing a raw material, raw materials are added into a preparation pot or a preparation tank, and as necessary, enzymes such as amylase are added into the pot or the tank, so as to perform pasteurization and saccharification, and thereafter, the resultant is filtrated and boiled, and solids such as coagulated proteins are then removed from the reaction solution in a clarification tank. Thereafter, a yeast is further added for fermentation, and the yeast is then removed by a filtration machine or the like. After that, water, and additives such as a flavor, an acidulant and a pigment, are added to the resultant, as necessary, so that a raw material can be prepared.

Besides, an antioxidant, a bitterness-imparting agent, a flavor, an acidulant, a pigment and the like may be added in predetermined amounts after completion of the fermentation step, but these additives may also be added at any given timing during the production process including pasteurization and saccharification steps. Thus, the timing of adding additives is not limited.

The yeast used in the present step can be selected, as appropriate, while taking into consideration the type of a fermented beverage to be produced, a flavor of interest, fermentation conditions, etc., and for the production of the beverage of the present invention, either a top fermentation yeast or a bottom fermentation yeast can be used, and a commercially available yeast such as a Weihenstephan-34 strain (as a bottom fermentation yeast) can also be used.

The yeast may be directly added as a yeast suspension into the raw material, or a slurry obtained by concentrating the yeast according to centrifugation or precipitation may be added into the raw material. Alternatively, after completion of the centrifugation, a residue obtained by completely removing a supernatant from the slurry may also be added. The additive amount of the yeast into the raw material solution can be determined, as appropriate, and it is, for example, approximately 5×10⁶ cells/mL to 1×10⁸ cells/mL.

The conditions applied upon performing alcoholic fermentation, such as fermentation temperature and fermentation period, can be determined, as appropriate. For example, fermentation may be carried out under fermentation conditions for the production of a common beer or a low-malt beer, namely, under conditions consisting of 8° C. to 25° C. and 5 to 10 days. The temperature (temperature increase or temperature decrease) of a fermentation solution or the pressure may be changed in the middle of the fermentation step.

In the beer-taste beverage of the present invention, the total nitrogen amount is 5 to 140 mg/100 mL, and the total polyphenol amount is 3 to 200 ppm by mass. By controlling the total nitrogen amount and total polyphenol amount within such ranges, a flavor suitable for beers derived from malts can be imparted to the present beer-taste beverage.

After completion of the fermentation step, steps performed in the production of a beer-taste beverage that are well known to those skilled in the art, such as a liquor storage step and a filtration step, may be carried out.

### <Steps (2) and (3)>

Step (2) is a step of mixing one or more types of raw materials that can be assimilated by the yeast into the raw material mixture. The raw materials that can be assimilated by the yeast, which are used in Step (2), are raw materials other than malts, which become a nitrogen source and a carbon source. For example, peas, coms (e.g. corn grits, etc.), rice, soya beans, yeast extracts and the like can be used, but raw materials other than these examples can also be used. Besides, since these raw materials also have influence on the taste and flavor of the beer-taste beverage, these raw materials are preferably selected, as appropriate, depending on drinkers' preferences.

In addition, Step (3) is a step of adding spirits derived from grains to the raw material mixture.

### <Step (4)>

Step (4) is a step of adjusting the content of 2,3-diethyl-5-methylpyrazine.

In the beer-taste beverage of the present invention, the content of 2,3-diethyl-5-methylpyrazine is preferably adjusted to be within the aforementioned range, and such a beverage can be produced by performing steps including Step (4). Herein, when the appropriate content can be achieved with 2,3-diethyl-5-methylpyrazine derived from raw materials, further addition of 2,3-diethyl-5-methylpyrazine is not necessary. On the other hand, 2,3-diethyl-5-methylpyrazine or an additive comprising 2,3-diethyl-5-methylpyrazine may be added in Step (4), so that the content of 2,3-diethyl-5-methylpyrazine in the beer-taste beverage may be adjusted.

In Steps (2) to (4), the components mixed in individual steps may be mixed into the raw materials before fermentation, or may also be mixed into the raw materials after fermentation. In addition, the components mixed may be added all at once, or may also be divided over multiple times and added.

Alternatively, the raw materials that can be assimilated by the yeast and spirits may be simultaneously mixed, and Steps (2) to (4) may be simultaneously carried out.

Further, when Steps (2) to (4) are carried out, other additives may be simultaneously mixed into the raw materials.

### 2.2 Method for Producing Non-Fermented Beer-Taste Beverage

The method for producing the non-fermented beer-taste beverage according to one embodiment of the present invention is not particularly limited, and the present production method is the same as a common method for producing a non-fermented beer-taste beverage, with the exception that the bitterness value, the total nitrogen amount, the total polyphenol amount, and the content of 2,3-diethyl-5-methylpyrazine are controlled in the present production method. In the case of producing a non-fermented beer-taste beverage, the specific production method may be a method which comprises producing a stock solution of a non-fermented beer-taste beverage having a bitterness value of 18 BUs or less, a total nitrogen amount of 5 to 140 mg/100 mL and a total polyphenol amount of 3 to 200 ppm by mass according to an ordinary method, and then adding 2,3-diethyl-5-methylpyrazine or a raw material comprising 2,3-diethyl-5-methylpyrazine to the stock solution, so as to adjust the content of 2,3-diethyl-5-methylpyrazine.

As an example of the method for producing a stock solution of a non-fermented beer-taste beverage, first, a wort, a sweetener, a flavor, and other components are mixed with one another in predetermined amounts, so as to prepare a mixture. Subsequently, a predetermined amount of drinking water is added to the mixture to prepare a primary raw material solution. The primary raw material solution is boiled, liquors are then added to the solution, and carbonated water is then added by a carbonation step.

The liquors to be added are not particularly limited, and for example, raw material alcohol, shochu, awamori, whiskey, brandy, spirits such as vodka, rum, tequila and gin, and the like can be used.

As necessary, a precipitate can be separated and removed by filtration, centrifugation, etc., in each step. Moreover, the above-described raw material solution may be produced in a thick state, and carbonated water may be then added to the thick raw material solution. By using a process of producing common soft drinks to perform the aforementioned operations, non-fermented beverages can be easily prepared without having fermentation equipment.

The removal of a precipitate before the carbonation step or the carbonated water-adding step is more desirable because substances causing dregs and off-flavors can be eliminated.

The thus obtained fermented beer-taste beverage and non-fermented beer-taste beverage according to one embodiment of the present invention are filled into predetermined containers, and are distributed as products to the market.

The method of filling the beer-taste beverage in a container is not particularly limited, and a method of filling a beverage in a container that is well known to those skilled in the art can be applied. By performing a step of filling a beer-taste beverage in a container, the beer-taste beverage of the present invention is filled and hermetically sealed in the container. In such a step of filling a beer-taste beverage in a container, containers having any forms and/or being made of any materials may be used, and examples of such a container are the containers described in “1.4 Container-packed beverage.”

### EXAMPLES

Hereinafter, the present invention will be described in more detail in the following examples, etc. However, these examples are not intended to limit the scope of the present invention.

Moreover, in the following examples, the original wort extract concentration, the total nitrogen amount, and the total polyphenol amount were measured according to the methods described in “Revised Version Brewery Convention of Japan (BCOJ) Beer Analysis Method (published by the Brewing Society of Japan, edited by Brewers Association of Japan, Brewery Convention of Japan [Analysis Committee], and enlarged and revised in 2013).”

### Examples 1 to 25 and Comparative Examples 1 to 5

<Preparation of Fermented Beverages with Hops>

Pulverized barley malts and corn grits were added into a preparation tank filled with 120 L of hot water, and the temperature was gradually increased and was then retained. The mixture was filtrated to remove malt lees and the like. Thereafter, the obtained raw material solution and hops were added into a boiling tank, and a sugar solution was then added thereto to achieve a designated percentage of malt used. The volume of the mixed solution was adjusted to 100 L with hot water, so as to obtain a hot wort. Specifically, the percentage of malts used in each of Examples 1 to 5 and Comparative Example 1 was adjusted to 70% by mass, the percentage of malts used in each of Examples 6 to 20 and Comparative Examples 2 to 4 was adjusted to 49% by mass, and the percentage of malts used in each of Examples 21 to 25 and Comparative Example 5 was adjusted to 25% by mass. In Examples 5, 10, 15, 20 and 25 and Comparative Examples 1 to 5, corn grits were not used as raw materials.

The obtained hot wort was cooled, and ventilation was then carried out using oxygen, so as to obtain 60 L of a pre-fermentation solution before addition of a yeast.

The thus obtained pre-fermentation solution was boiled and was then cooled. After that, thereafter, a beer yeast (bottom fermentation yeast) was added to the obtained fermentation moromi-mash, and fermentation was then carried out for about 1 week. Thereafter, a maturation period was passed further for about 1 week, and the yeast was then removed by filtration. An extract-adjusting water was added to the resulting solution to prepare a beer-taste beverage.

The original wort extract concentration, the total nitrogen amount, the total polyphenol amount, the total nitrogen amount/the total polyphenol amount, and the content of 2,3-diethyl-5-methylpyrazine in the thus obtained beer-taste beverages are as shown in Table 1 to Table 5. Moreover, the pH of the beverages in all of the examples and the comparative examples was less than pH 4.2.

### Examples 26 to 35 and Comparative Examples 6 and 7

<Preparation of Fermented Beverages without Hops>

Beer-taste beverages were prepared in the same manner as that of Examples 1 to 25, with the exception that hops were not used as raw materials.

The original wort extract concentration, the total nitrogen amount, the total polyphenol amount, the total nitrogen amount/the total polyphenol amount, and the content of 2,3-diethyl-5-methylpyrazine in the thus obtained beer-taste beverages are as shown in Table 6 and Table 7. Moreover, the pH of the beverages in all of the examples and the comparative examples was less than pH 4.55.

### Examples 36 to 42 and Comparative Example 8

<Preparation of Non-Fermented Beverages without Hops>

Water, a collagen peptide, a barley extract, liquid sugar, an acidulant, a beer flavor, and wheat spirits were used as raw materials, and these raw materials were mixed with one another to obtain a raw material solution. A fermentation step using a yeast was not performed on the obtained raw material solution, and 2,3-diethyl-5-methylpyrazine was added to the raw material solution to achieve the content shown in Table 8. In addition, carbon dioxide gas was added to the resulting solutions in Examples 36 to 42 and Comparative Example 8, so as to prepare alcoholic beer-taste beverages having a carbon dioxide gas percentage of 0.520 w/w %, a pH value of less than 4.0, and an alcohol percentage of 5.0 to 5.6 (v/v) %.

### <Sensory Evaluation>

### Evaluation of “Flavor Suitable for Beer-Taste Beverages” and “Tight Feeling Suitable for Beer-Taste Beverages” of Obtained Beer-Taste Beverages

The same 4 panelists tasted the obtained beer-taste beverages and evaluated as follows.

Individual panelists tasted the beer-taste beverages cooled to about 4° C. Thereafter, with regard to the “flavor suitable for beer-taste beverages” and the “tight feeling suitable for beer-taste beverages,” evaluation was carried out based on the following score criteria, with scores in 0.1 steps in the range of 3.0 (maximum value) to 1.0 (minimum value), and the mean value of the scores given by the 4 panelists was then calculated. The results are shown in Table 1 to Table 8.

For the evaluation, samples whose “flavor suitable for beer-taste beverages” corresponded to the following criteria “1.0,” “2.0,” and “3.0,” and samples whose “tight feeling suitable for beer-taste beverages” corresponded to the following criteria “1.0,” “2.0,” and “3.0,” had previously been prepared, and thus, the standards among individual panelists were intended to be unified. Moreover, in all of the sensory evaluations shown in Tables 1 to 8, a score value difference of 2.0 or more was not found among individual panelists, with respect to an identical beverage.

### [Flavor Suitable for Beer-Taste Beverages]

“3.0”: Extremely favorable.
“2.0”: Favorable.
“1.0”: Poor.

Then, based on the mean value of the scores of the 4 panelists, the flavor suitable for beer-taste beverages was evaluated for each beverage according to the criteria, and a beverage having a score of 2.0 or more was determined to be satisfactory.

### [Tight Feeling Suitable for Beer-Taste Beverages]

“3.0”: Not felt.
“2.0”: Hardly felt.
“1.0”: Felt.

Then, based on the mean value of the scores of the 4 panelists, the tight feeling suitable for beer-taste beverages was evaluated for each beverage according to the criteria, and a beverage having a score of 2.0 or more was determined to be satisfactory.

### [Comprehensive Evaluation]

A beverage, in which the score of the “flavor suitable for beer-taste beverages” is 2.0 or more and the score of the “tight feeling suitable for beer-taste beverages” is 2.0 or more, was evaluated to be “A”

On the other hand, a beverage, in which the score of the “flavor suitable for beer-taste beverages” is less than 2.0 or the score of the “tight feeling suitable for beer-taste beverages” is less than 2.0, was evaluated to be “B.”

### [Table A]

TABLE 1

| | | Ex 1 | Ex 2 | Ex 3 | Ex. 4 | Ex 5 | Comp.Ex. 1 |
|---|---|---|---|---|---|---|---|
| Percentage of malts used | % by mass | 70 | 70 | 70 | 70 | 70 | 70 |
| Corn grits (○: used, ×: not used) | | ○ | ○ | ○ | ○ | × | × |
| Bitterness value | BUs | 10 | 10 | 10 | 10 | 10 | 10 |
| Original wort extract (O-Ex) conc. | % by mass | 13 | 13 | 13 | 13 | 13 | 13 |
| Total nitrogen amount | mg/100 mL | 105.0 | 105.0 | 105.0 | 105.0 | 100.0 | 100.0 |
| Total polyphenol amount | ppm by mass | 160.9 | 160.9 | 160.9 | 160.9 | 160.9 | 160.9 |
| Total nitrogen amount/total | (mg/100 mL)/ | 0.65 | 0.65 | 0.65 | 0.65 | 0.62 | 0.62 |
| polyphenol amount | (ppm by mass) | | | | | | |
| 2,3-Diethyl-5-methylpyrazine | ppb by mass | 0.1 | 1 | 10 | 30 | 0.02 | 0.01 |
| Flavor suitable for beer-flavored | | 2.5 | 2.5 | 3 | 3 | 2.5 | 2.5 |
| beverages | | | | | | | |
| Tight feeling suitable for beer-flavored | | 2 | 2.5 | 3 | 3 | 2 | 1.5 |
| beverages | | | | | | | |
| Comprehensive evaluation | | A | A | A | A | A | B |

TABLE 2

| | | Ex 6 | Ex 7 | Ex 8 | Ex 9 | Ex 10 | Comp.Ex. 2 |
|---|---|---|---|---|---|---|---|
| Percentage of malts used | % by mass | 49 | 49 | 49 | 49 | 49 | 49 |
| Corn grits (○: used, ×: not used) | | ○ | ○ | ○ | ○ | × | × |
| Bitterness value | BUs | 15 | 15 | 15 | 15 | 15 | 15 |
| Original wort extract (O-Ex) conc. | % by mass | 13.8 | 13.8 | 13.8 | 13.8 | 13.8 | 13.8 |
| Total nitrogen amount | mg/100 mL | 65.0 | 65.0 | 65.0 | 65.0 | 60.0 | 60.0 |
| Total polyphenol amount | ppm by mass | 83.7 | 83.7 | 83.7 | 83.7 | 83.7 | 83.7 |
| Total nitrogen amount/total | (mg/100 mL)/ | 0.78 | 0.78 | 0.78 | 0.78 | 0.72 | 0.72 |
| polyphenol amount | (ppm by mass) | | | | | | |
| 2,3-Diethyl-5-methylpyrazine | ppb by mass | 0.1 | 1 | 10 | 30 | 0.02 | 0.01 |
| Flavor suitable for beer-flavored | | 2 | 2.5 | 3 | 3 | 2 | 2 |
| beverages | | | | | | | |
| Tight feeling suitable for beer-flavored | | 2 | 2.5 | 3 | 3 | 2 | 1.5 |
| beverages | | | | | | | |
| Comprehensive evaluation | | A | A | A | A | A | B |

TABLE 3

| | | Ex 11 | Ex 12 | Ex 13 | Ex 14 | Ex 15 | Comp.Ex. 3 |
|---|---|---|---|---|---|---|---|
| Percentage of malts used | % by mass | 49 | 49 | 49 | 49 | 49 | 49 |
| Corn grits (○: used, ×: not used) | | ○ | ○ | ○ | ○ | × | × |
| Bitterness value | BUs | 10 | 10 | 10 | 10 | 10 | 10 |
| Original wort extract (O-Ex) conc. | % by mass | 13.8 | 13.8 | 13.8 | 13.8 | 13.8 | 13.8 |
| Total nitrogen amount | mg/100 mL | 74.1 | 74.1 | 74.1 | 74.1 | 69.1 | 69.1 |
| Total polyphenol amount | ppm by mass | 83.7 | 83.7 | 83.7 | 83.7 | 83.7 | 83.7 |
| Total nitrogen amount/total | (mg/100 mL)/ | 0.89 | 0.89 | 0.89 | 0.89 | 0.83 | 0.83 |
| polyphenol amount | (ppm by mass) | | | | | | |
| 2,3-Diethyl-5-methylpyrazine | ppb by mass | 0.1 | 1 | 10 | 30 | 0.02 | 0.01 |
| Flavor suitable for beer-flavored | | 2 | 2.5 | 3 | 3 | 2 | 2 |
| beverages | | | | | | | |
| Tight feeling suitable for beer-flavored | | 2 | 2 | 2.5 | 3 | 2 | 1.5 |
| beverages | | | | | | | |
| Comprehensive evaluation | | A | A | A | A | A | B |

TABLE 4

| | | Ex 16 | Ex 17 | Ex 18 | Ex 19 | Ex 20 | Comp.Ex. 4 |
|---|---|---|---|---|---|---|---|
| Percentage of malts used | % by mass | 49 | 49 | 49 | 49 | 49 | 49 |
| Corn grits (○: used, ×: not used) | | ○ | ○ | ○ | ○ | × | × |
| Bitterness value | BUs | 5 | 5 | 5 | 5 | 5 | 5 |
| Original wort extract (O-Ex) conc. | % by mass | 13.8 | 13.8 | 13.8 | 13.8 | 13.8 | 13.8 |
| Total nitrogen amount | mg/100 mL | 70.0 | 70.0 | 70.0 | 70.0 | 60.0 | 60.0 |
| Total polyphenol amount | ppm by mass | 83.7 | 83.7 | 83.7 | 83.7 | 83.7 | 83.7 |
| Total nitrogen amount/total | (mg/100 mL)/ | 0.84 | 0.84 | 0.84 | 0.84 | 0.72 | 0.72 |
| polyphenol amount | (ppm by mass) | | | | | | |
| 2,3-Diethyl-5-methylpyrazine | ppb by mass | 0.1 | 1 | 10 | 30 | 0.02 | 0.01 |
| Flavor suitable for beer-flavored | | 2 | 2.5 | 3 | 3 | 2 | 2 |
| beverages | | | | | | | |
| Tight feeling suitable for beer-flavored | | 2 | 2 | 2.5 | 2.5 | 2 | 1.5 |
| beverages | | | | | | | |
| Comprehensive evaluation | | A | A | A | A | A | B |

TABLE 5

| | | Ex 21 | Ex 22 | Ex 23 | Ex 24 | Ex 25 | Comp.Ex. 5 |
|---|---|---|---|---|---|---|---|
| Percentage of malts used | % by mass | 25 | 25 | 25 | 25 | 25 | 25 |
| Corn grits (○: used, ×: not used) | | ○ | ○ | ○ | ○ | × | × |
| Bitterness value | BUs | 10 | 10 | 10 | 10 | 10 | 10 |
| Original wort extract (O-Ex) conc. | % by mass | 11.01 | 11.01 | 11.01 | 11.01 | 11.01 | 11.01 |
| Total nitrogen amount | mg/100 mL | 37.1 | 37.1 | 37.1 | 37.1 | 32.1 | 32.1 |
| Total polyphenol amount | ppm by mass | 34.1 | 34.1 | 34.1 | 34.1 | 34.1 | 34.1 |
| Total nitrogen amount/total | (mg/100 mL)/ | 1.09 | 1.09 | 1.09 | 1.09 | 0.94 | 0.94 |
| polyphenol amount | (ppm by mass) | | | | | | |
| 2,3-Diethyl-5-methylpyrazine | ppb by mass | 0.1 | 1 | 10 | 30 | 0.02 | 0.01 |
| Flavor suitable for beer-flavored | | 2 | 2.5 | 2 | 2.5 | 2 | 1.5 |
| beverages | | | | | | | |
| Tight feeling suitable for beer-flavored | | 2 | 2 | 2.5 | 2.5 | 2 | 2 |
| beverages | | | | | | | |
| Comprehensive evaluation | | A | A | A | A | A | B |

TABLE 6

| | | Ex 26 | Ex 27 | Ex 28 | Ex 29 | Ex 30 | Comp.Ex. 6 |
|---|---|---|---|---|---|---|---|
| Percentage of malts used | % by mass | 70 | 70 | 70 | 70 | 70 | 70 |
| Corn grits (○: used, ×; not used) | | ○ | ○ | ○ | ○ | × | × |
| Bitterness value | BUs | Less than 1.0 | Less than 1.0 | Less than 1.0 | Less than 1.0 | Less than 1.0 | Less than 1.0 |
| Original wort extract (O-Ex) conc. | % by mass | 12.2 | 12.3 | 12.4 | 12.2 | 12.2 | 12.2 |
| Total nitrogen amount | mg/100 mL | 98.4 | 99.2 | 100.0 | 98.0 | 93.2 | 93.2 |
| Total polyphenol amount | ppm by mass | 151.1 | 151.0 | 153.3 | 150.7 | 155.2 | 150.0 |
| Total nitrogen amount/total | (mg/100 mL)/ | 0.65 | 0.66 | 0.65 | 0.65 | 0.60 | 0.62 |
| polyphenol amount | (ppm by mass) | | | | | | |
| 2,3-Diethyl-5-methylpyrazine | ppb by mass | 0.1 | 1 | 10 | 30 | 0.02 | 0.01 |
| Flavor suitable for beer-flavored | | 2.3 | 2.3 | 2.7 | 2.8 | 2.2 | 2.3 |
| beverages | | | | | | | |
| Tight feeling suitable for beer-flavored | | 2 | 2.4 | 2.7 | 2.8 | 2 | 1.3 |
| beverages | | | | | | | |
| Comprehensive evaluation | | A | A | A | A | A | B |

TABLE 7

| | | Ex 31 | Ex 32 | Ex 33 | Ex 34 | Ex 35 | Comp.Ex. 7 |
|---|---|---|---|---|---|---|---|
| Percentage of malts used | % by mass | 25 | 25 | 25 | 25 | 25 | 25 |
| Corn grits (○: used, ×; not used) | | ○ | ○ | ○ | ○ | × | × |
| Bitterness value | BUs | Less than 1.0 | Less than 1.0 | Less than 1.0 | Less than 1.0 | Less than 1.0 | Less than 1.0 |
| Original wort extract (O-Ex) conc. | % by mass | 10.08 | 10 | 9.9 | 9.95 | 9.99 | 10.01 |
| Total nitrogen amount | mg/100 mL | 34.0 | 33.7 | 33.0 | 33.1 | 29.5 | 28.0 |
| Total polyphenol amount | ppm by mass | 31.0 | 30.0 | 30.2 | 31.0 | 31.0 | 31.0 |
| Total nitrogen amount/total | (mg/100 mL)/ | 1.10 | 1.12 | 1.09 | 1.07 | 0.95 | 0.90 |
| polyphenol amount | (ppm by mass) | | | | | | |
| 2,3-Diethyl-5-methylpyrazine | ppb by mass | 0.1 | 1 | 10 | 30 | 0.02 | 0.01 |
| Flavor suitable for beer-flavored | | 2 | 2.2 | 2.2 | 2.3 | 2 | 1.4 |
| beverages | | | | | | | |
| Tight feeling suitable for beer-flavored | | 2 | 2.1 | 2.2 | 2.3 | 2 | 1.8 |
| beverages | | | | | | | |
| Comprehensive evaluation | | A | A | A | A | A | B |

TABLE 8

| | | Ex. 36 | Ex. 37 | Ex 38 | Ex. 39 | Ex. 40 | Ex 41 | Ex. 42 | Comp.Ex 8 |
|---|---|---|---|---|---|---|---|---|---|
| Percentage of malts used | % by mass | 0 | 0 | 0 | 0 | 0 | 0 | 0 | 0 |
| Corn grits (○: used, ×: not used) | | × | × | × | × | × | × | × | × |
| collagen peptide | mg/100 mL | 50 | 100 | 300 | 600 | 100 | 100 | 100 | 100 |
| Bitterness value | BUs | Less | Less | Less | Less | Less | Less | Less | Less |
| | | than 1.0 | than 1.0 | than 1.0 | than 1.0 | than 1.0 | than 1.0 | than 1.0 | than 1.0 |
| Original wort extract (O-Ex) conc. | % by mass | 8.2 | 8.1 | 8.1 | 7.9 | 8.1 | 8.1 | 8.1 | 8.1 |
| Total nitrogen amount | mg/100 mL | 10.2 | 25.3 | 60.5 | 121.2 | 25.3 | 25.3 | 25.3 | 25.3 |
| Total polyphenol amount | ppm by mass | 9.0 | 16.0 | 12.0 | 13.0 | 16.0 | 16.0 | 16.0 | 16.0 |
| Total nitrogen amount/total | (mg/100 mL)/ | 1.13 | 1.58 | 5.04 | 9.32 | 1.58 | 1.58 | 1.58 | 1.58 |
| polyphenol amount | (ppm by mass) | | | | | | | | |
| 2,3-Diethyl-5-methylpyrazine | ppb by mass | 1 | 1 | 1 | 1 | 0.1 | 10 | 30 | 0.01 |
| Flavor suitable for beer-flavored | | 2.1 | 2.2 | 2.2 | 2.5 | 2 | 2.2 | 2.4 | 1.3 |
| beverages | | | | | | | | | |
| Tight feeling suitable | | 2.1 | 2.2 | 2.3 | 2.4 | 2 | 2.3 | 2.5 | 1.6 |
| for beer-flavored beverages | | | | | | | | | |
| Comprehensive evaluation | | A | A | A | A | A | A | A | B |

From the results of the Examples, it was found that, when fermented beer-taste beverages and non-fermented beer-taste beverages, in each of which the bitterness value is 18 BUs or less, the total nitrogen amount is 5 to 140 mg/100 mL and the total polyphenol amount is 3 to 200 ppm by mass, comprise 0.02 ppb by mass or more of 2,3-diethyl-5-methylpyrazine, beverages having a flavor suitable for beer-taste beverage and a tight feeling suitable for beer-taste beverages can be provided.

1. A beer-taste beverage, in which a bitterness value is 18 BUs or less, the total nitrogen amount is 5 to 140 mg/100 mL, the total polyphenol amount is 3 to 200 ppm by mass, and the content of 2,3-diethyl-5-methylpyrazine is 0.02 ppb by mass or more.

2. The beer-taste beverage according to claim 1, wherein the bitterness value is 5 BUs or less.

3. The beer-taste beverage according to claim 1, which does not substantially contain components derived from hops.

4. The beer-taste beverage according to claim 1, wherein the content of 2,3-diethyl-5-methylpyrazine is 100 ppb by mass or less.

5. The beer-taste beverage according to claim 1, wherein the original wort extract (0-Ex) concentration is 5% to 18% by mass.

6. The beer-taste beverage according to claim 1, wherein the total nitrogen amount (mg/100 mL)/the total polyphenol amount (ppm by mass) is 0.2 to 3.0.

7. The beer-taste beverage according to claim 1, wherein at least a portion of nitrogen or polyphenol is derived from malts.

8. The beer-taste beverage according to claim 1, wherein at least a portion of nitrogen or polyphenol is derived from corns.

9. The beer-taste beverage according to claim 1, wherein the percentage of malts used is 90% by mass or less.

10. The beer-taste beverage according to claim 1, wherein the percentage of malts used is 0% by mass.

11. The beer-taste beverage according to claim 1, wherein the beer-taste beverage is a fermented beer-taste beverage.

12. The beer-taste beverage according to claim 1, wherein the beer-taste beverage is a non-fermented beer-taste beverage.

13. A method for producing the beer-taste beverage according to claim 11, which comprises:
a step of adding a yeast to water and raw materials that can be assimilated by the yeast, and performing alcoholic fermentation.

14. The method for producing the beer-taste beverage according to claim 13, wherein the raw materials that can be assimilated by the yeast comprise malts and corns, and the percentage of malts used is 90% by mass or less.
